(19) United States
(12) Patent Application Publication
(10) Pub. No.: US 2017/0276185 A1
(43) Pub. Date: Sep. 28, 2017

(54) TEXTURED BALL TRACKS IN TRIPOT TYPE HOUSINGS

(71) Applicant: Steering Solutions IP Holding Corporation, Saginaw, MI (US)

(72) Inventors: Jon N. Miller, Merrill, MI (US); Eduardo Mondragon, Freeland, MI (US); Jeffrey P. Courville, Frankenmuth, MI (US)

(21) Appl. No.: 15/281,714

(22) Filed: Sep. 30, 2016

Related U.S. Application Data
(60) Provisional application No. 62/313,296, filed on Mar. 25, 2016.

(51) Int. Cl. F16D 3/205; B23C 3/30; B23D 37/22; B24B 1/00

(52) U.S. Cl. CPC F16D 3/2055; B24B 1/00; B23C 3/30; B23D 37/22

(57) ABSTRACT

A tripot housing includes a housing body that extends between a first housing end and a second housing end along an axis. The housing body defines a guide channel that extends from the first housing end towards the second housing end. The guide channel has a first wall, a second wall, and a third wall that extends between the first wall and the second wall. At least one of the first wall, the second wall, and the third wall includes a selectively textured functional area.

### CROSS-REFERENCES TO RELATED APPLICATIONS

This patent application claims priority to US Provisional Patent Application Ser. No. 62/313,296, filed Mar. 25, 2016 which is incorporated herein by reference in its entirety.

### BACKGROUND OF THE INVENTION

Tripot joints interconnect rotary shaft members of a vehicle. The tripot joint includes a tripot housing that is manufactured through a forming process.

Standard and premium tripot housings are commonly manufactured through a forming process. Housings made through such a process have some disadvantages that may include classification or distortion.

Classification is an operation performed to mate the housing to a spider assembly and control clearance and the corresponding rotational lash of the resulting assembly. Classification also requires carrying an inventory of several classes.

Distortion may be present in different forms, which range from non-straight tracks or skewed bores. Such distortion induces variation in rotational lash and in the levels of Generated Axial Force (GAF) in the tripot joint. Excessive variation in GAF may be experienced by drivers in the form of shudder.

### SUMMARY OF THE INVENTION

According to an embodiment of the present disclosure, a tripot housing is provided. The tripot housing includes a housing body that extends between a first housing end and a second housing end along an axis. The housing body defines a guide channel that extends from the first housing end towards the second housing end. The guide channel has a first wall, a second wall, and a third wall that extends between the first wall and the second wall. At least one of the first wall, the second wall, and the third wall includes a selectively textured functional area.

According to another embodiment of the present disclosure, a tripot housing is provided. The tripot housing includes a housing body having an outer surface and an inner surface each extending between a first housing end and a second housing end along an axis. The inner surface of the housing body defines a separator and a guide channel. The separator radially extends towards the axis and axially extends from the first housing end towards the second housing end. The guide channel is disposed adjacent to the separator. The guide channel radially extends towards the outer surface and axially extends from the first housing end towards the second housing end. The guide channel has a first wall, a second wall, and a third wall extending between the first wall and the second wall. At least one of the first wall, the second wall, and the third wall includes a first selectively textured functional area.

According to yet another embodiment of the present disclosure, a method of manufacturing a tripot housing is provided. A housing body is provided. The housing body extends between a first housing end and a second housing end along an axis. A plurality of guide channels are formed into the housing body. The plurality of guide channels axially extend from the first housing end towards the second housing end. The plurality of guide channels are radially spaced apart each other about the axis. At least one of the plurality of guide channels is selectively textured to define a selectively textured functional area by a metal removing process.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a tripot joint;

FIG. 2 is a first partial sectional view of a tripot housing of the tripot joint;

FIG. 3 is a cross-sectional view of the tripot housing of FIG. 2;

FIG. 4 is a plot illustrating generated axial force vs. joint angle;

FIG. 5 is a profile view of the tripot housing having formed guide channels without selectively textured functional areas;

FIG. 6 is a profile view of the tripot housing having formed guide channels with selectively textured functional areas; and

FIGS. 7-10 are illustrative views of a dominant lay of a selectively textured functional area of the tripot housing.

### DETAILED DESCRIPTION

Referring now to the Figures, where the invention will be described with reference to specific embodiments, without limiting same, it is to be understood that the disclosed embodiments are merely illustrative of the invention that is embodied in various and alternative forms. The figures are not necessarily to scale; some features are exaggerated or minimized to show details of particular components. Therefore, specific structural and functional details disclosed herein are not to be interpreted as limiting, but merely as a representative basis for teaching one skilled in the art to variously employ the present invention.

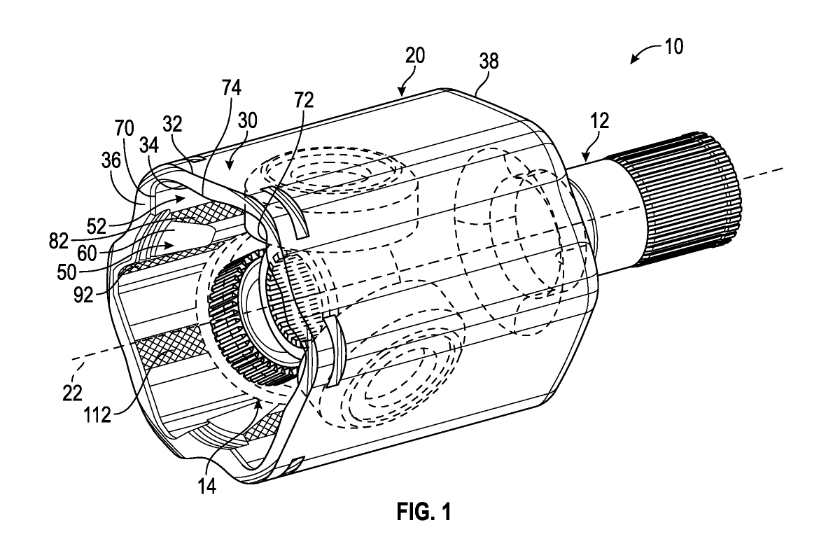

Referring to FIG. 1, a tripot joint 10 enables torque transfer between two rotatable shaft members with possible axial position or angular position changes relative to each other. The tripot joint 10 is configured to transmit torque from the first shaft member 12 to a second shaft member through a spider member 14 that is operatively connected to the second shaft member through various rotational speeds, joint angles, or telescopic positions.

The tripot joint 10 includes a tripot housing 20 that extends from the first shaft member 12 along an axis 22. The combination of the tripot housing 20 and the first shaft member 12 are rotatable about the axis 22. A direction of travel of a ball set or ball member disposed on the spider member 14 is disposed substantially parallel to the axis 22.

The tripot housing 20 includes a housing body 30. The housing body 30 has an outer surface 32 and an inner surface 34 each extending between a first housing end 36 and the second housing end 38 along the axis 22. The first shaft member 12 is connected to the housing body 30 proximate the second housing end 38.

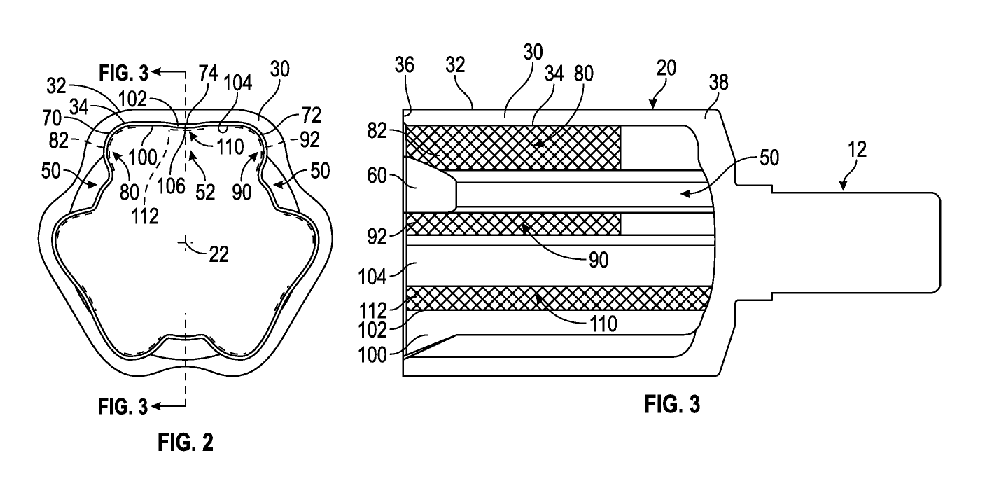

Referring to FIGS. 1 and 2, the inner surface 34 of the housing body 30 defines a separator 50 and a plurality of ball tracks, lubricated ball bores, or guide channels 52. The separator 50 radially extends from the inner surface 34 of the housing body 30 towards the axis 22. The separator 50 axially extends from the first housing and 36 towards the second housing end 38. The separator 50 defines a chamfer 60 disposed proximate the first housing end 36. The chamfer 60 extends from the inner surface 34 of the housing body 30 towards a surface of the separator 50 and is disposed in a non-perpendicular relationship with the inner surface 34 and the surface of the separator 50.

Each guide channel 52 axially extends along and is disposed substantially parallel to the axis 22. Each guide channel 52 radially extends towards the outer surface 32 of the housing body 30. The tripot joint 10 includes three guide channels that are radially spaced apart from each other about the axis 22 by a separator 50 such that each guide channel 52 is disposed adjacent to the separator 50. Each guide channel 52 is configured to receive a portion of the spider member 14 such that the spider member 14 is received within the housing body 30 of the tripot housing 20.

Each guide channel 52 of the housing includes a first wall 70, a second wall 72, and a third wall 74. The first wall 70 and the second wall 72 extend away from the axis 22 towards the third wall 74.

The first wall 70 is disposed opposite the second wall 72. The third wall 74 extends between the first wall 70 and the second wall 72. The third wall 74 is disposed further from the axis 22 than the first wall 70 and the second wall 72. The first wall 70 and the second wall 72 have a generally arcuate or a generally piecewise concave profile when viewed in a cross-section transverse to the axis 22, as shown in FIG. 2.

The first wall 70 defines a first functional area 80. The first functional area 80 extends between the separator 50 and the third wall 74. The first functional area 80 is disposed on the first wall 70 and at least a portion of the separator 50 that is disposed adjacent to the guide channel 52.

The first functional area 80 is configured to be in contact with a portion of the spider member 14 such as a ball member of a ball set disposed on the spider member 14. The first functional area 80 is selectively textured. Selectively texturing may be done by a process that enhances the surface roughness or applies a pattern that extends into, extends above, or is disposed on the surface of the first functional area 80. The selective texturing of the first functional area 80 defines a first selectively textured functional area 82. The first selectively textured functional area 82 extends from the first housing and 36 towards the second housing end 38.

The second wall 72 defines a second functional area 90. The second functional area 90 faces towards the first functional area 80. The second functional area 90 extends between another separator 50 and the third wall 74. The second functional area 90 is disposed on the second wall 72 in at least a portion of another separator 50 that is disposed adjacent to the guide channel 52.

The second functional area 90 is configured to be in contact with a portion of the spider member 14 such as a ball member of a ball set disposed on the spider member 14. The second functional area 90 is selectively textured. Selectively texturing may be done by a process that enhances the surface roughness or applies a pattern that extends into, extends above, or is disposed on the surface of the second functional area 90. The selective texturing of the second functional area 90 defines a second selectively textured functional area 92. The second selectively textured functional area 92 extends from the first housing and 36 towards the second housing end 38.

The third wall 74 is defined by a first wall portion 100, a second wall portion 102, and a third wall portion 104. The first wall portion 100 extends between an end of the first wall 70 and the second wall portion 102. The second wall portion 102 extends between the first wall portion 100 and the third wall portion 104. The second wall portion 102 is configured as a protuberance or a protrusion 106 that extends towards the axis 22. The third wall portion 104 extends between the second wall portion 102 and an end of the second wall 72.

At least a portion of the third wall 74 defines a third functional area 110. The third functional area 110 is defined by the second wall portion 102. In at least one embodiment, the third functional area 110 may be defined by at least one of the first wall portion 100, the second wall portion 102, and the third wall portion 104.

The third functional area 110 is configured to be in contact with a portion of the spider member 14 such as a ball member of a ball set disposed on the spider member 14. The third functional area 110 is selectively textured. Selectively texturing may be done by a process that enhances the surface roughness or applies a pattern that extends into, extends above, or is disposed on the surface of the first functional area 80. The selective texturing of the third functional area 110 defines a third selectively textured functional area 112. The third selectively textured functional area 112 extends from the first housing end 36 towards the second housing end 38.

The guide channels 52 are formed into the inner surface 34 of the housing body 30 of the tripot housing 20 prior to the first functional area 80, the second functional area 90, and the third functional area 110 of the guide channels 52 being selectively textured by a metal removing process. The metal removing process may be a hard milling process, a soft milling process, a grinding process, an erosive process, an electrical discharge machining process, an electrochemical machining process, a hard broaching process, a soft broaching process, or the like. In at least one embodiment, the first functional area 80, the second functional area 90, and the third functional area 110 are selectively textured by the metal removing process subsequent to heat treating of the housing body 30 of the tripot housing 20.

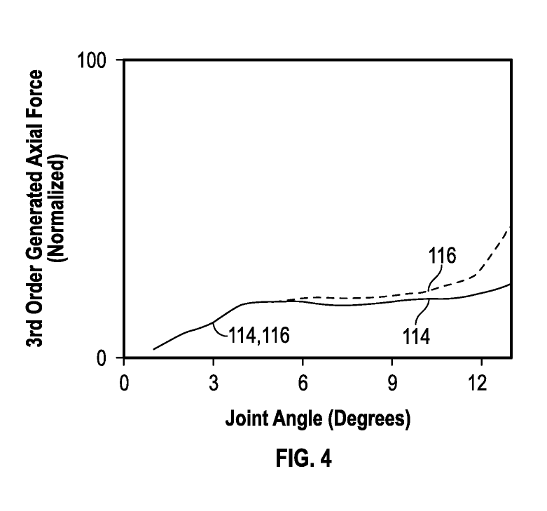

The selective texturing of the first functional area 80, the second functional area 90, and the third functional area 110 to define the first selectively textured functional area 82, the second selectively textured functional area 92, and the third selectively textured functional area 112 changes an average roughness (Ra), with respect to the average roughness resulting from forming the tripot housing 20, of the surface of at least one of the first functional area 80, the second functional area 90, and the third functional area 110 to have been average roughness (Ra) of less than 3. The selective texturing of the first functional area 80, the second functional area 90, and the third functional area 110 may improve the generated axial force (GAF) performance of the tripot joint 10. As shown in FIG. 4, as a joint angle of the tripot joint 10 increases, a generated axial force (GAF) 114 experienced by the tripot joint 10 having a tripot housing 20 provided with guide channels 52 that are formed and are provided with selectively textured functional areas (82, 92, 112) is less than a generated axial force (GAF) 116 experienced by a tripot joint having a tripot housing provided with formed channels without selectively textured functional areas.

The selective texturing of the first functional area 80, the second functional area 90, and the third functional area 110 to define the first selectively textured functional area 82, the second selectively textured functional area 92, and the third selectively textured functional area 112 provides a profile tolerance tighter than 150 microns.

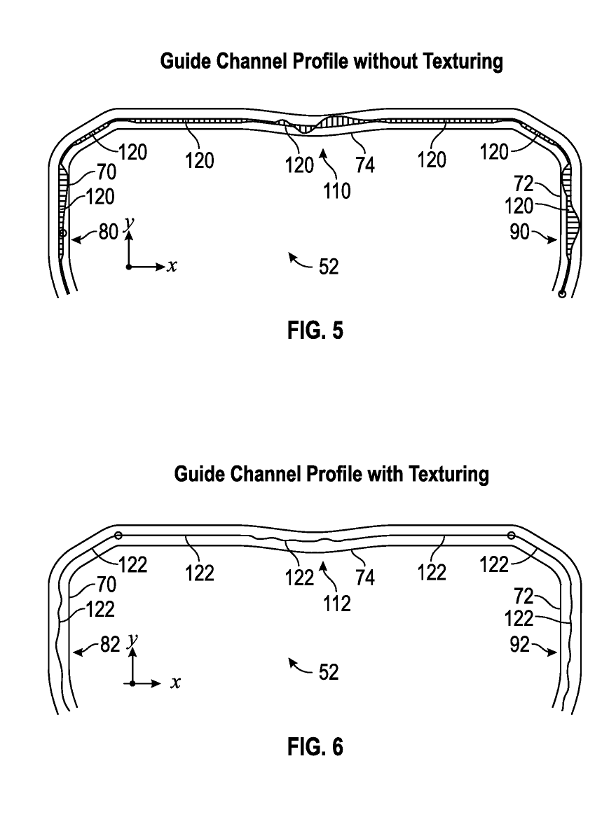

Referring to FIG. 5, a profile view of the tripot housing 20 having formed guide channels 52 without selectively textured functional areas is shown. The profile 120 varies outside of the profile tolerance of 150 microns and may negatively impact the GAF such that the GAF increases as the joint angle of the tripot joint 10 increases.

Referring to FIG. 6, another profile view of the tripot housing having formed guide channels 52 with selectively textured functional areas (82, 92, 112) is shown. The profile 122 is well controlled and is tighter than 150 microns. The tighter profile tolerances reduces the GAF as the joint angle of the tripot joint 10 increases as compared to guide channels not having selectively textured functional areas.

A ratio of the profile tolerance to the average roughness (Ra) of the selectively textured functional areas is within or between a range of 20:1 and 2000:1. The lower end of the ratio derives from a profile tolerance of approximately 50 microns and an average surface roughness of approximately 2.5. The upper end of the ratio derives from a profile tolerance of approximately 100 microns and an average surface roughness of approximately 0.05. The benefits of the selective texturing may be reduced or mitigated when a surface roughness is rougher than 2.5 microns and the profile tolerance goes beyond 100 microns.

At least one of the first selectively textured functional area 82, the second selectively textured functional area 92, and the third selectively textured functional area 112 may reduce form variation of at least one of the first functional area 80, the second functional area 90 and the third functional area 110.

At least one of the first selectively textured functional area 82, the second selectively textured functional area 92, and the third selectively textured functional area 112 are textured such that the selectively textured functional areas has a dominant lay 130. The material removal process enables the direction of the dominant lay 130 be controlled.

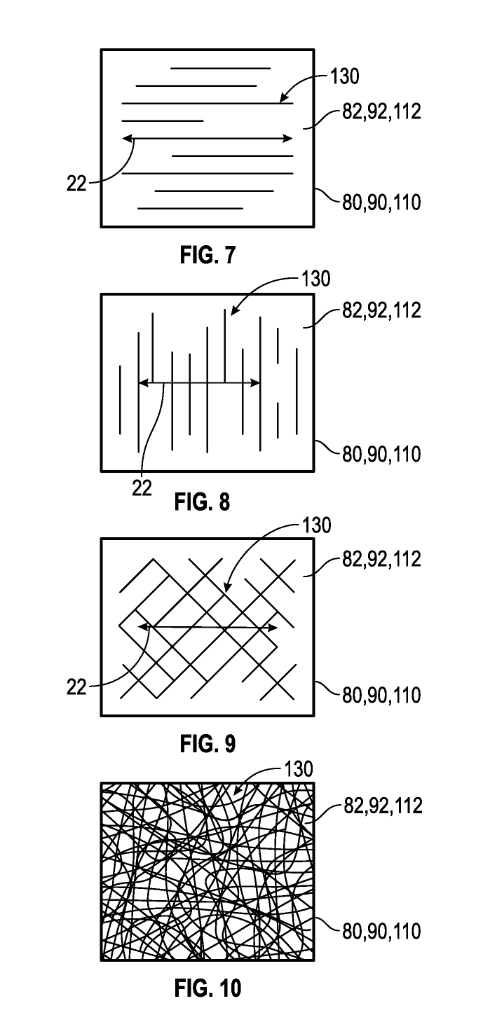

Referring to FIG. 7, the dominant lay 130 of at least one of the first selectively textured functional area 82, the second selectively textured functional area 92, and the third selectively textured functional area 112 is disposed substantially parallel to the axis 22.

Referring to FIG. 8, the dominant lay 130 of at least one of the first selectively textured functional area 82, the second selectively textured functional area 92, and the third selectively textured functional area 112 is disposed substantially perpendicular to the axis 22.

Referring to FIG. 9, the dominant lay 130 of at least one of the first selectively textured functional area 82, the second selectively textured functional area 92, and the third selectively textured functional area 112 is an angular lay such that the dominant lay 130 is disposed in a non-parallel relationship and a non-perpendicular relationship with the axis 22.

Referring to FIG. 10, the dominant lay 130 of at least one of the first selectively textured functional area 82, the second selectively textured functional area 92, and the third selectively textured functional area 112 is a multidirectional lay.

The selective texturing of at least one of the first functional area 80, the second functional area 90, and the third functional area 110 may improve traction of a ball member of the ball set disposed on the spider member 14 in a lubricated ball bore or lubricated guide channel 52 of the tripot housing 20. The selective texturing minimizes sliding, which creates friction forces several orders of magnitude higher than the friction forces associated with rolling.

The selective texturing and form controlling of at least one of the first functional area 80, the second functional area 90, and the third functional area 110 improves tracking of a ball member of the ball set disposed on the spider member 14 within the guide channel 52 of the tripot housing 20. The improved tracking reduces sliding friction and provides a more consistent generated axial force, thus reducing shuddering or other phenomenon. The selective texturing and form controlling of at least one of the first functional area 80, the second functional area 90, and the third functional area 110 may eliminate distortion during heat treating of the tripot housing 20, resulting in guide channels 52 that are symmetric having a tight form tolerance. The tighter form tolerance provides a more consistent generated axial force of the tripot joint 10. The tighter form tolerances of the tripot joint 10 having selectively textured functional areas provides a narrower generated axial force distribution than the generated axial force distribution corresponding to tripot joints having formed only housings.

Throughout this specification, the term “attach,” “attachment,” “connected”, “coupled,” “coupling,” “mount,” or “mounting” shall be interpreted to mean that a structural component or element is in some manner connected to or contacts another element, either directly or indirectly through at least one intervening structural element, or is integrally formed with the other structural element.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A tripot housing, comprising:
a housing body extending between a first housing end and a second housing end along an axis, the housing body defining a guide channel that extends from the first housing end towards the second housing end, the guide channel having a first wall, a second wall, and a third wall extending between the first wall and the second wall, at least one of the first wall, the second wall, and the third wall includes a selectively textured functional area.

2. The tripot housing of claim 1, wherein the third wall is defined by a first wall portion, a second wall portion, and a third wall portion.

3. The tripot housing of claim 2, wherein the first wall portion extends between the first wall and the second wall portion and wherein the third wall portion extends between the second wall and the second wall portion.

4. The tripot housing of claim 3, wherein the selectively textured functional area is disposed on the second wall portion.

5. The tripot housing of claim 4, wherein the second wall portion is configured as a protrusion that extends towards the axis.

6. The tripot housing of claim 1, wherein an average roughness (Ra) of the selectively textured functional area is less than 3.

7. The tripot housing of claim 1, wherein a ratio of a profile tolerance to an average roughness (Ra) of the selectively textured functional area is between 20:1 and 2000:1.

8. The tripot housing of claim 1, wherein the selectively textured functional area is prepared by a metal removing process.

9. A tripot housing, comprising:
a housing body having an outer surface and an inner surface each extending between a first housing end and a second housing end along an axis, the inner surface of the housing body defining:
a separator radially extending towards the axis and axially extending from the first housing end towards the second housing end, and
a guide channel disposed adjacent to the separator, the guide channel radially extending towards the outer surface and axially extending from the first housing end towards the second housing end, the guide channel having a first wall, a second wall, and a third wall extending between the first wall and the second wall, at least one of the first wall, the second wall, and the third wall includes a first selectively textured functional area.

10. The tripot housing of claim 9, wherein the first selectively textured functional area is disposed on the first wall and is disposed on at least a portion of the separator disposed adjacent to the first wall.

11. The tripot housing of claim 10, wherein a second selectively textured functional area is disposed on the second wall.

12. The tripot housing of claim 11, wherein a third selectively textured functional area is disposed on the third wall.

13. The tripot housing of claim 12, wherein a dominant lay of at least one of the first selectively textured functional area, the second selectively textured functional area, and the third selectively textured functional area is disposed parallel to the axis.

14. The tripot housing of claim 12, wherein a dominant lay of at least one of the first selectively textured functional area, the second selectively textured functional area, and the third selectively textured functional area is disposed perpendicular to the axis.

15. The tripot housing of claim 12, wherein at least one of the first selectively textured functional area, the second selectively textured functional area, and the third selectively textured functional area has at least one of a multidirectional lay and an angular lay.

16. A method of manufacturing a tripot housing, comprising:
providing a housing body extending between a first housing end and a second housing end along an axis;
forming a plurality of guide channels that axially extend from the first housing end towards the second housing end and the plurality of guide channels are radially spaced apart each other about the axis; and
selectively texturing at least one of the plurality of guide channels to define a selectively textured functional area by a metal removing process.

17. The method of claim 16, wherein the metal removing process is at least one of a hard milling process and a soft milling process.

18. The method of claim 16, wherein the metal removing process is at least one of a grinding process and an erosive process.

19. The method of claim 16, wherein the metal removing process is at least one of a hard broaching process and a soft broaching process.
